(19) United States
(12) Patent Application Publication
(10) Pub. No.: US 2024/0351510 A1
(43) Pub. Date: Oct. 24, 2024

(54) LATCH-EXTENSION SYSTEM FOR ROLL-OFF DUMPSTER

(71) Applicant: HORIZON TRAILERS LLC, EL PASO, TX (US)

(72) Inventors: BERNHARD LOEWEN NEUFELD, Riva Palacio (MX); JACOB LOEWEN NEUFELD, Riva Palacio (MX); Carlos Ledezma Arevalo, Cuauhtemoc (MX)

(21) Appl. No.: 18/642,678

(22) Filed: Apr. 22, 2024

Related U.S. Application Data
(60) Provisional application No. 63/497,766, filed on Apr. 24, 2023.

(51) Int. Cl. B60P 7/13; B60P 1/64

(52) U.S. Cl. CPC B60P 7/13; B60P 1/6418

(57) ABSTRACT

A latch-extension assembly having an extension bar, with a latch assembly on one end, a latch-pin assembly on the other end, and a support assembly attached to the extension bar near the latch end. The extension bar length may be fixed or adjustable. The support assembly may have a socket permanently attached to the extension bar which may removably receive a support pillar, with attachment feature. The pillar may have a base with an attachment feature such as a clamp adapted to mount the support pillar on a vehicle lift frame or rail. A latch-extension system may have two latch-extension assemblies, which may be left and right mirror images, and may be joined by a bracing rod fastened to the support pillars, and by a pivot extension rod that enables both latches to be operated by a single latch handle on either side of the vehicle.

### BACKGROUND OF THE INVENTION

This invention relates generally to roll-off dumpsters, more particularly to a latch system for attaching the roll-off dumpster on a vehicle, and specifically to a latch-extension system that permits roll-off dumpsters of various lengths to be used on a vehicle meant for a longer-length roll-off dumpster.

Roll-off dumpsters, or simply roll-offs, are large bins or containers for hauling materials like trash, debris, granular materials, or the like. Flatbed roll-offs are for loading palletized materials, vehicles, or the like. In each case, the roll-off is transported on a vehicle chassis to a desired location, the vehicle includes a tilting frame and winch and the roll-off includes two rear rollers or wheels. The tilting frame is raised and the roll-off allowed to slide off the frame onto the ground for use at that location. Later, the process is reversed—the roll-off is winched onto the tilted frame and the frame is lowered back onto the vehicle chassis. The vehicle may be a truck or a trailer. The vehicle and roll-off are usually sized proportionately so that the roll-off weight is distributed properly with respect to the vehicle axles.

What is needed is a way to fit smaller roll-offs onto larger vehicles with proper weight distribution so that the vehicle may have multiple uses.

### SUMMARY OF THE INVENTION

The present invention is directed to systems and methods which provide a way to utilize larger roll-off vehicles with a range of smaller sized roll-offs, whether dumpsters, flatbeds, or other roll-off types.

The invention is directed to a latch-extension assembly having an extension bar, a latch assembly on one end of the extension bar, a latch-pin assembly on the other end of the extension bar and a support assembly attached to the extension bar closer to the latch assembly than the latch-pin assembly. The extension bar may be of fixed length, or of adjustable length. An adjustable length extension bar may be telescoping and may have two pieces or sections that telescope together. The two pieces may have through holes to accommodate a lock pin to fix the length in discrete positions. The support assembly may have a socket permanently attached to the extension bar which may removably receive a support pillar, with attachment feature. The pillar may have a base with an attachment feature adapted to mount the support pillar on a vehicle lift frame or rail. The support-pillar attachment feature may be a clamping feature.

The invention is also directed to a latch-extension system having two latch-extension assemblies, a left form and a right form, which may be left and right mirror images of the latch-extension assembly described above. The latch-extension assemblies may be joined by a bracing rod fastened at each end to one of the support pillars. The latch assemblies may be joined by a pivot extension rod that is adapted to enable both latches to be operated by a latch handle on either side of the vehicle.

The invention is also directed to a vehicle equipped with a lift frame adapted for roll-offs and having one or more of the latch-extension-bar assemblies described above, or having a latch-extension bar system as described above.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

The accompanying drawings, which are incorporated in and form part of the specification in which like numerals designate like parts, illustrate embodiments of the present invention and together with the description, serve to explain the principles of the invention. In the drawings:

FIG. 1 is a partially fragmented perspective view of a typical roll-off trailer system;

FIG. 2 is a side view of a typical roll-off trailer system in a loaded and tilted position;

FIG. 3 is a partially fragmented perspective view of a roll-off trailer system with a latch-extension system according to a first embodiment of the invention;

FIG. 4 is a partially exploded, perspective view of a latch-extension bar according to the first embodiment of the invention in a retracted position;

FIG. 5 is a perspective view of the latch-extension bar of FIG. 4;

FIG. 6 is another perspective view of the latch-extension bar of FIG. 4;

FIG. 7 is a side view of the latch-extension bar according to the first embodiment of the invention in the extended position;

FIG. 8 is a side view of the latch-extension bar according to the first embodiment of the invention in the retracted position;

FIG. 9 is a perspective view of the latch-extension bar according to the first embodiment of the invention in an extended position;

FIG. 10 is another perspective view of the latch-extension bar according to the first embodiment of the invention in an extended position;

FIG. 11 is another perspective view of the latch-extension bar according to the first embodiment of the invention in an extended position;

FIG. 12 is another perspective view of the latch-extension bar according to the first embodiment of the invention in an extended position;

FIG. 13 is a perspective view of a latch-extension bar according to a second embodiment of the invention;

FIG. 14 is another perspective view of the latch-extension bar of FIG. 13;

FIG. 15 is another perspective view of the latch-extension bar of FIG. 13;

FIG. 16 is a side view of the latch-extension bar of FIG. 13;

FIG. 17 is a perspective view of a portion of the second embodiment showing the end fittings in more detail;

FIG. 18 is another perspective view of a portion of the second embodiment showing one end fitting in more detail; and

FIG. 19 is another perspective view of a portion of the second embodiment showing one end fitting in more detail.

### DETAILED DESCRIPTION

The present invention is directed to systems and methods which provide a way to utilize larger roll-off vehicles with a range of smaller sized roll-offs, whether dumpsters, flatbeds, or other roll-off types. Herein, directional indications such as front, rear, left, right, top, bottom and the like are used with respect to a vehicle hauling a roll-off dumpster.

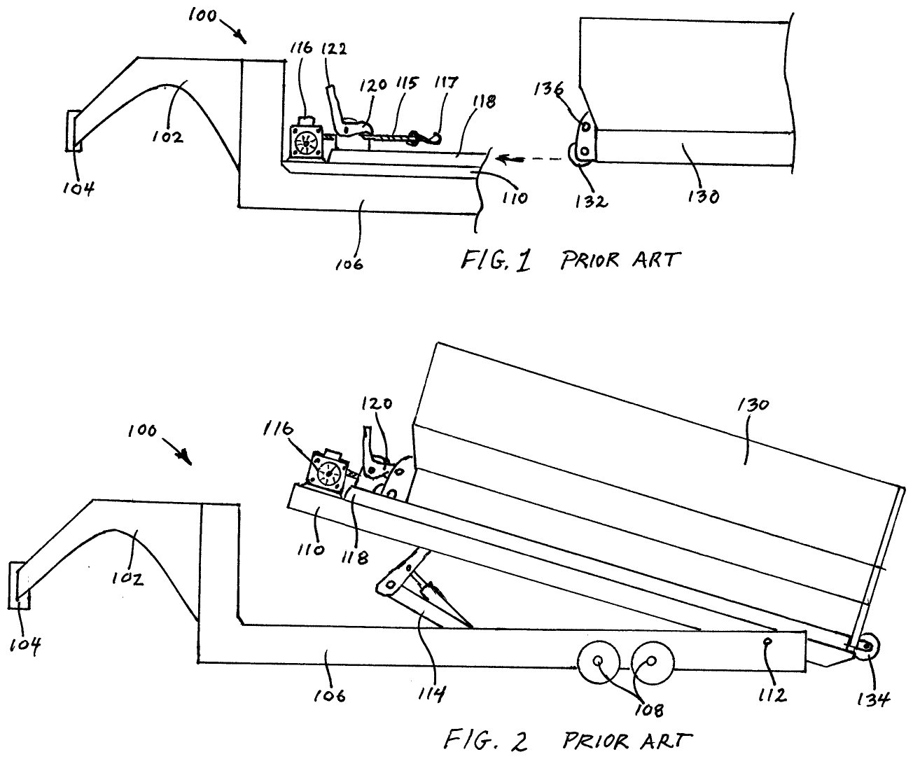

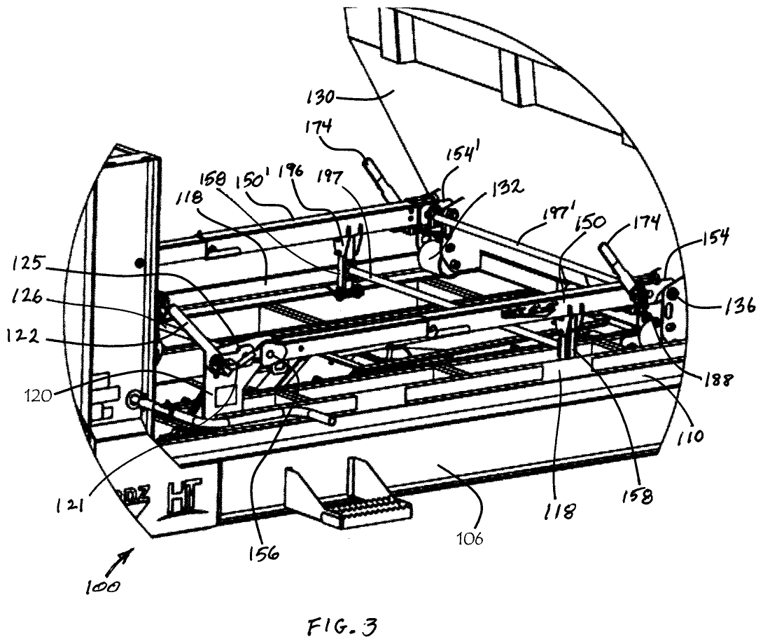

Embodiments of the invention work with a particular style of roll-off system having one or more latches on the tilting frame which latch onto a latch pin or bar located on the front of the roll-off when the roll-off is properly loaded onto the vehicle. The purpose of the latch is to keep the roll-off on the vehicle during transport. This type of roll-off latch system is illustrated in FIGS. 1 and 2. It should be understood the invention can be used with any type of truck, trailer or vehicle so adapted for roll-off use, as well as with any type of roll-off, including a bin, dumpster, or flatbed, or the like.

In FIG. 1 and FIG. 2, vehicle 100 is shown as a gooseneck trailer. Vehicle 100 includes gooseneck 102, with fifth-wheel hitch or coupling 104, attached to vehicle chassis 106, which is shown with tandem axles 108. Lift frame 110 is pivotably attached at the rear of chassis 106 via pivot 112, so that it can be tilted by lift apparatus 114. Winch 116 is attached to the front of lift frame 110 and has hook 117 for easily connecting winch cable 115 to a towing eye (not shown) on the front of a roll-off. The lift frame 110 also has latch body 120 attached in a position to engage latch pin 136 (also referred to as a latch bar) on the front of roll-off 130. In this example, there are actually two latches connected by transverse rod 126 (see FIG. 3) so that both latches can be operated simultaneously by latch handle 122 from one side of the vehicle. FIG. 3 also shows a little more detail for the latches. Latch body 120 includes latch hook or catch 125 which has handle 122 as a lever arm to open and close the latch. Latch lock pin 121 may be provided to either lock the handle in the open position for unloading the roll-off 130 or in the closed position for securing the roll-off on the vehicle. Transverse rod 126 may include a lever arm (not shown) resiliently connected to tilt frame 110 with a spring (not shown) to torque the transverse rod 126 and bias both of the latches into their closed position. The latches thus will engage latch bars 136 on the roll-off automatically.

In typical use, the tow cable and towing hook are attached to a towing eye or ring on the front of the roll-off. Then the tilt apparatus is activated to tilt the tilt frame as shown in FIG. 2 and the winch is activated to let the roll-off slide down the tilt frame until the rear wheels or rear rollers 134 of the roll-off reach the ground. The vehicle may then be pulled forward from under the roll-off. Loading the roll-off back onto the vehicle involves using the same winch, cable and tow hook, engaging the towing eye and pulling the roll-off back onto the vehicle. The tile frame includes two angle-iron rails 118 oriented as shown in FIG. 3, so that front rollers 132 of the roll-off roll on the base of the angle iron and the roll-off is guided between the vertical rails 118.

Other arrangements for rails and rollers are possible and would work with the inventive extension system. For example, another common design uses rollers embedded in the guide rails instead of on the front of the roll-off.

It should be understood that the invention to be described can be used with a gooseneck trailer such as shown, or with a bumper hitch trailer, or with a truck adapted for roll-off use, or any other suitably equipped vehicle. It should also be understood that the invention to be described may be used with any type of roll-off, including roll-off dumpsters, roll-off bins, roll-containers of any variety, or roll-off flatbeds.

FIG. 3 shows a first embodiment of the invention in use with a roll-off dumpster that is about six feet shorter than the design length of the trailer. The latch-extension system essentially provides a latch at a location rearward from the front of the vehicle where it is suitable for engaging a shorter roll-off than the vehicle was meant for. This enables the shorter roll-off to be positioned properly over the vehicle axles for proper weight distribution while still securing it in place with the latches. In FIG. 3, the latch-extension system includes left extension-bar assembly 150, right extension-bar assembly 150′, connected by transverse bracing rod 197 and transverse pivot rod 197′. The two extension-bar assemblies include left and right latch-pin assemblies 156 affixed at the respective forward end of the extension bar assemblies, which are adapted to engage with the two latches 125, in place of the latch pins on the roll-off. At the opposite end of each extension bar are affixed two latch assemblies 154 and 154′ which are adapted to engage the latch pins 136 on a roll-off. Each extension bar is supported by respective support assembly 158, which clamps onto its respective angle-iron rail 118. Transverse bracing rod 197 is between and connected to support assemblies 158 to maintain separation between extension-bar assemblies 150 and 150′ and to prevent support assemblies 158 from disengaging from the rails 118 they are clamped to.

Safety chains are usually provided in case a latch should fail. The vehicle will generally be equipped with a first chain attached to the lift frame near latch 120. That chain is normally hooked to the roll-off. When the latch extender is in use, that chain can be hooked to a special eye 186 on the front end of the extension-bar assembly 150. The back end of the extension-bar assembly 150 is equipped with a chain 188 which can be hooked to the roll-off, thus completing the chain safety system.

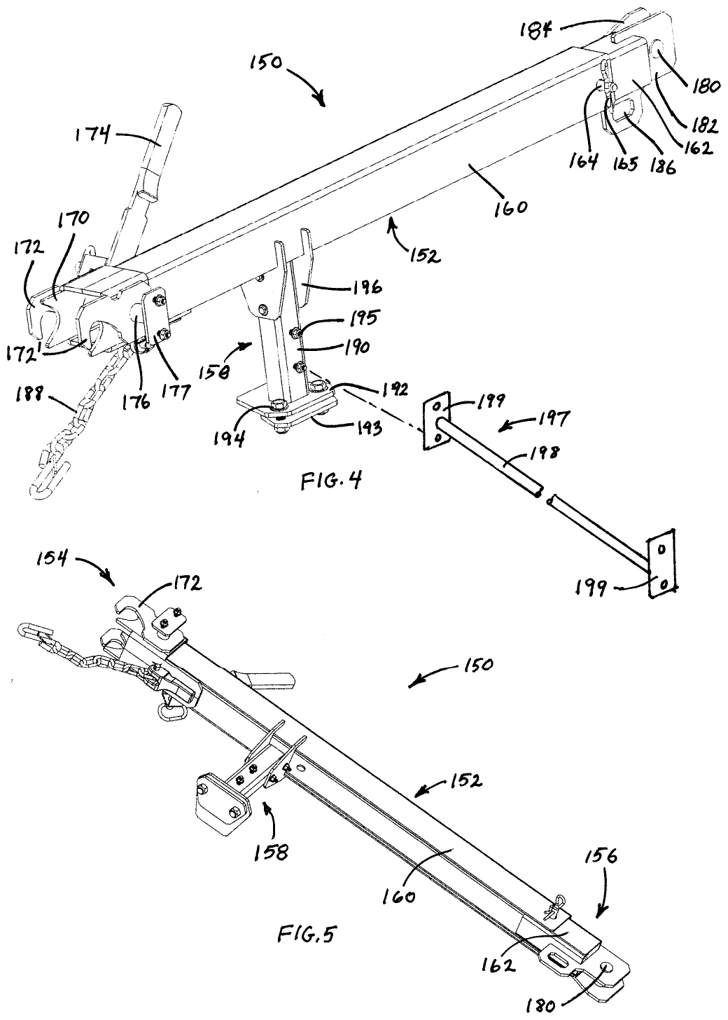

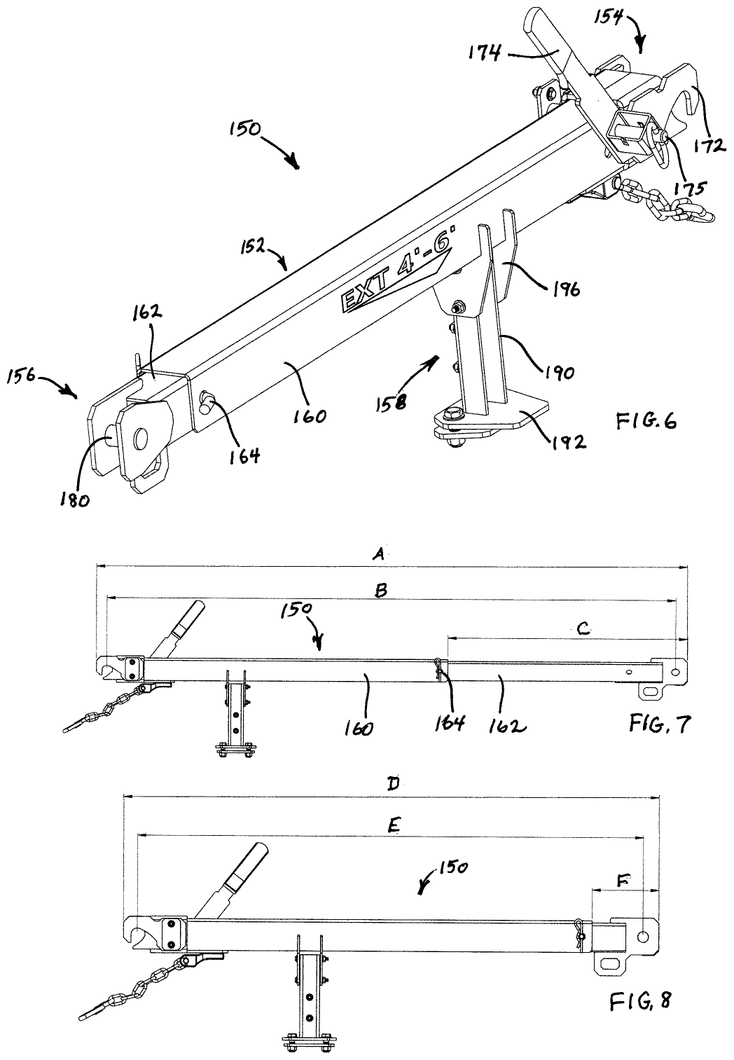

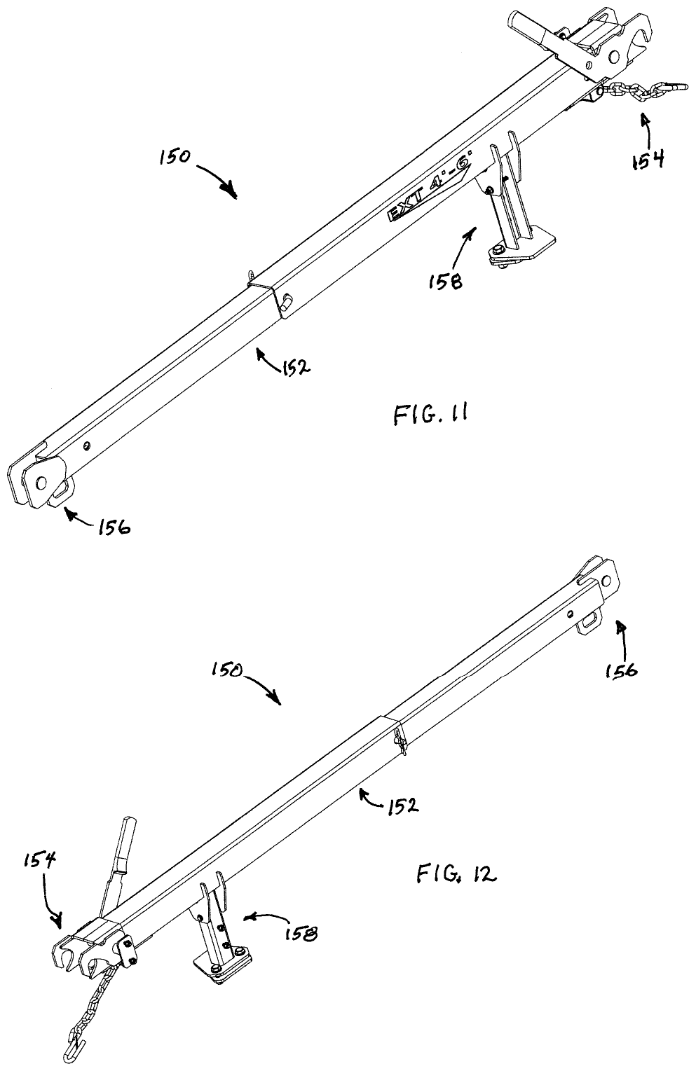

FIGS. 4-12 show the first embodiment of FIG. 3 in more detail. This embodiment is adjustable. In particular, it can collapse from about a six-foot extension down to about four feet in length. Of course, these 4-foot and 6-foot options were chosen to fit common sizes of roll-offs, but any desired length(s) could be chosen for the latch-extension system by one of skill in the art. Thus, it should be understood that the lengths may be chosen as needed and are not limited to the four-foot and six-foot lengths mentioned. These lengths are mentioned since most dumpsters come in lengths that are an even number of feet, e.g., 10-foot, 12-foot, 14-foot, etc., as do trailers and other vehicles that are meant for roll-offs. Since left extension-bar assembly 150 and right extension-bar assembly 150′ are mirror images of each other, only left extension-bar assembly 150 is shown in FIGS. 4-12. It should be understood that the discussion applies equally to the right extension-bar assembly 150′.

FIGS. 4-12 show the main features of extension-bar assembly 150, namely latch-pin assembly 156 at the forward end of extension bar 152, latch assembly 154 at the opposite end of extension bar 152, and support assembly 158 located under the extension bar a short distance from the latch assembly end. Each of these components will now be described in more detail.

In this first embodiment, two-piece extension bar 152 has two sections which telescope together. First extension bar section 160 is the outer component, and second extension bar section 162 is the inner component. In two positions, through holes in the sides of the bar sections 160 and 162 align so that locking pin 164 or equivalent can be inserted to fix the length of extension bar 152. Locking pin 164 may be retained with cotter pin 165. The extension bar may be constructed from any suitable material or shape. In the drawings, extension bar 152 is made from two sizes of U-channel (for example iron channel) which nest together. Other holes could be added for the locking pin if more choices of length, i.e., fixing positions, are desired.

Latch-pin assembly 156 includes latch pin 180 mounted between two latch pin plates, first latch pin plate 182 and second latch pin plate 184. The two plates are attached to an end of extension bar 152, in this case the end of the smaller U-channel section 162. One of the plates, in this case first latch pin plate 182, may include an eye 186 or ring or the like for attaching a hook on a safety chain. The plates may be welded onto the end of the bar section. Iron or steel is a preferred material.

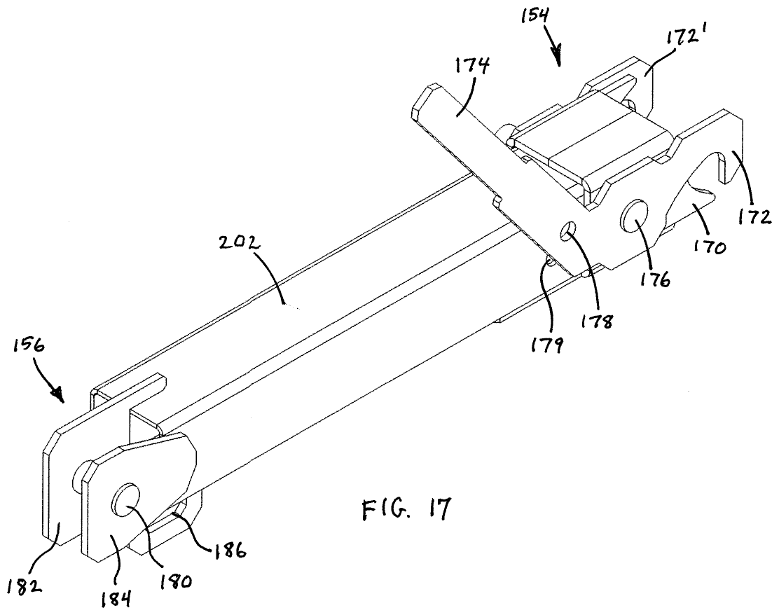

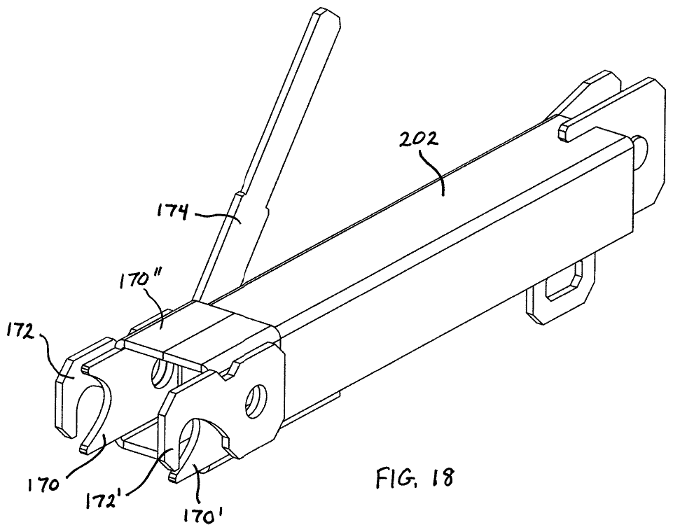

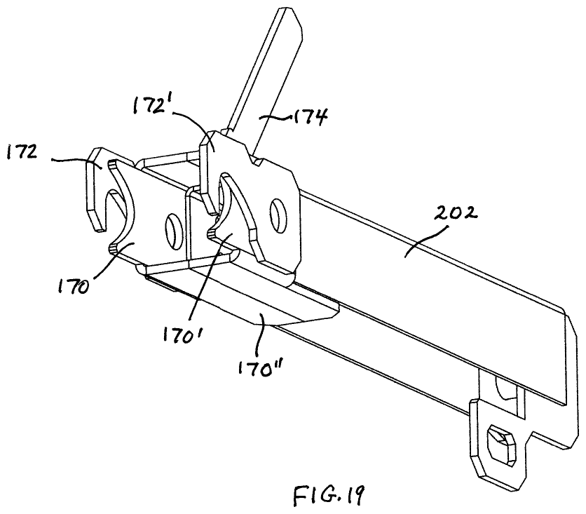

Latch assembly 154 is located at the opposite end of extension bar 152 from latch-pin assembly 156. In this case, that means mounted on the end of the larger U-channel section 160. The arrangement could be reversed. Latch assembly 154 includes latch body 170 shown mounted directly on the end of extension bar section 160. Latch body 170 includes the fixed, strike portion of the latch. Latch pivot 176 passes through latch body 170 and has latch hook 172 fixed thereon just outside and adjacent to latch body 170. In this exemplary embodiment, there are two latch hooks, 172 and 172′ fixed on the latch pivot 176 on opposite sides of the latch body 170. Latch body 170 also has two fixed strike portions 170 and 170′ connected by the main latch body 170′″ (see FIGS. 17-19). Latch hook 172 includes latch handle 174 which can be used to open or close the latch, or rather the double latch. Handle 174 and latch hook 172 may be one component as shown more clearly in FIG. 17. A locking feature, such as latch locking pin 175, may be provided to lock the latch open or closed. FIG. 17 shows hole 178 in handle 174 which may align with hole 179 in the extension bar, or with another hole not visible, for insertion of latch locking pin 175. The latch may also be spring loaded so that it is biased toward the locked position. The latch may be self actuated when a latch pin in a roll-off is engaged. The latch may be locked in the open position or the closed position as needed during use. The two latches may be reversed to make a left latch assembly 154 and a right latch assembly 154′.

Support assembly 158 includes support pillar 190, base 192, and socket 196. Support pillar 190 has a support base 192 affixed thereon. Base 192 is adapted for securely fastening to a lift frame on a vehicle transporting roll-offs. Fasteners such as bolts, screws, clamps, or the like may be used. The figures show a clamping feature which is useful for angle-iron rails 118 in FIGS. 1-3. Base 192 forms an upper clamp plate which works with lower clamp plate 193 and clamp bolts 194 to form a clamping feature. Socket 196 may be affixed to extension bar section 160. Socket 196 is adapted to accept pillar 190 and fasten thereto. It is advantageous to use removable fasteners such as the bolts shown in the figures. Then the support pillar 158 (or both support pillars) can be positioned on or clamped to rails 118 or tilt frame 110 before installing brace rod 197 and extension-bar assemblies 150 and 150′. It may be advantageous to affix support assembly 158 to the mid-section of extension bar 150, i.e., somewhere in the middle of the extension bar. It is preferred to affix support assembly 158 closer to the end with latch assembly 154, as indicated in FIGS. 3-5, 7-12, and 15-16.

In actual use, the extension bar system may incorporate two extension-bar assemblies, namely a right assembly 150′ and a left assembly 150. Transverse bracing rod assembly 197 shown in FIG. 4 may be used to link together and brace the two support assemblies of the two extension bar system. Each end of brace rod 198 has an attachment feature fixed thereon. In FIG. 4 the attachment feature is on end of rod 198 is plate 199 having bolt holes for attaching to matching tapped holes on support pillar 190 with bolts 195. Other attachment features could be used, such as couplings, nuts and bolts, welds, and the like. Bolts are easy to use and make for easy disassembly for storage or transport.

As shown in the figures, latch pivot 176 may have an attachment feature fixed on the end opposite handle 174. The attachment feature shown is pivot attachment plate 177. Both left extension-bar assembly 150 and right extension-bar assembly 150′ may have pivot attachment plate 177 on its latch pivot 176. Then a latch-pivot rod 197′, having the exact same structure as brace rod 197, with plates 199 at each end, but a little shorter in length, may be attached with nuts and bolts or other equivalent fasteners to attachment plates 177, thus connecting both left and right latch assemblies for simultaneous operation of the pivots or latch pivots from either side of the vehicle.

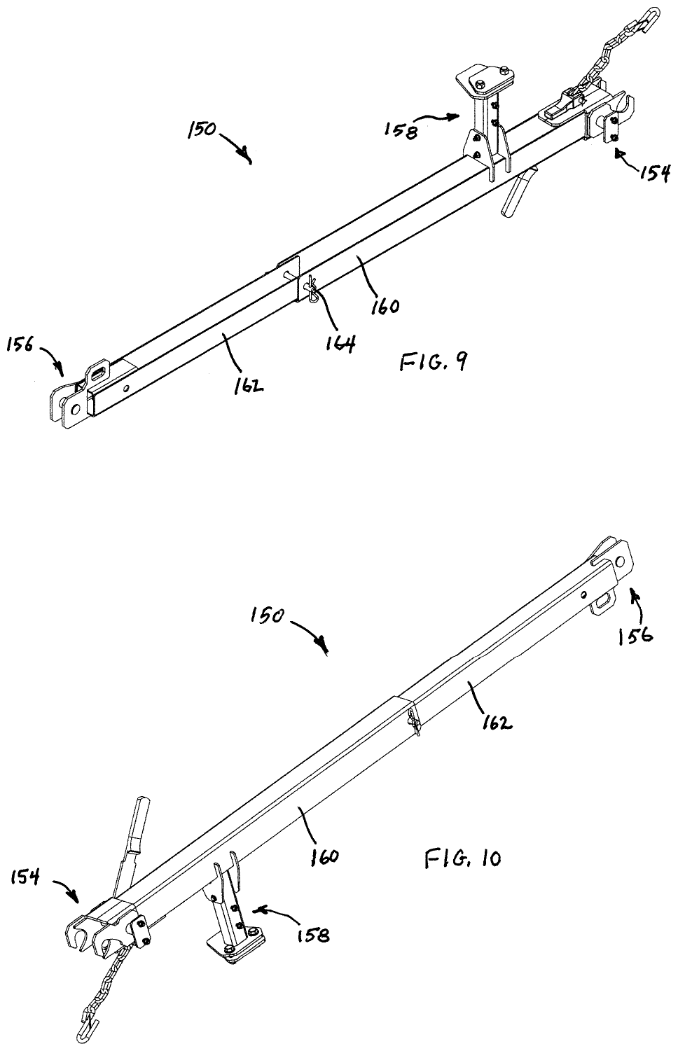

FIGS. 4-6 and FIG. 8 show the extendable, adjustable extension bar 152 in a retracted or shorter position. FIG. 7 and FIGS. 9-12 show the extension bar 152 in and extended position.

FIG. 7 and FIG. 8 indicate exemplary dimensions for extension bar 152 in its extended and retracted positions, respectively. As suggested above, it may be advantageous to provide for a two-foot difference between the two positions since roll-offs typically are sized in two-foot increments. The TABLE explains the meaning of the dimensions. The dimensions may be chosen according to the roll-off dimensions to be accommodated.

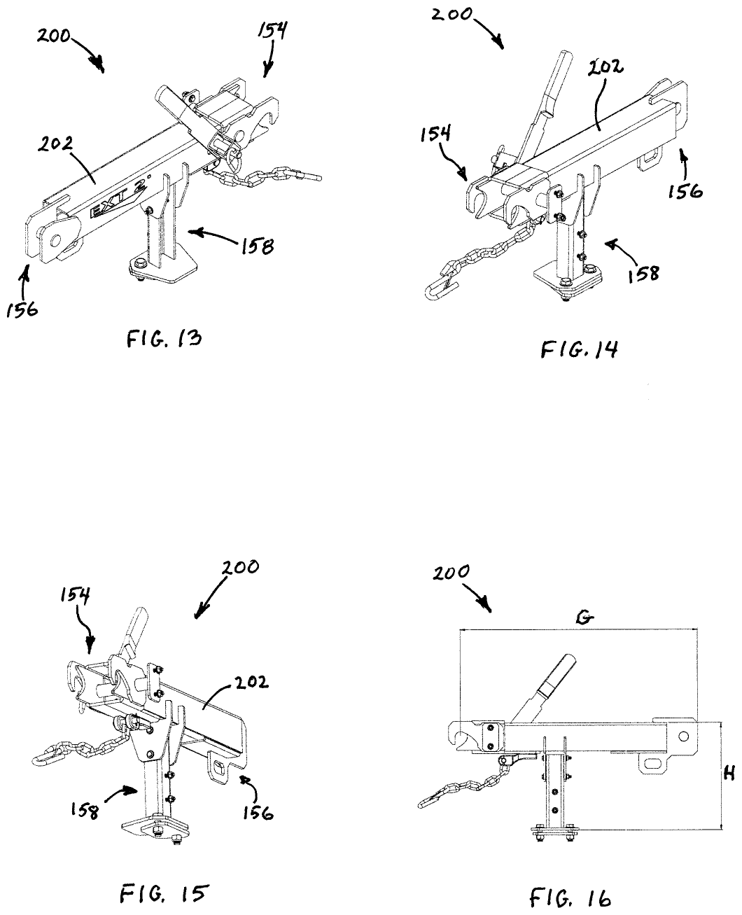

FIGS. 13-16 show a second embodiment of the invention. This embodiment is fixed in length. The fixed length could be any desired length, such as about two feet, about 4 feet or about 6 feet, or more, or any desired length in between. The illustrations are of a two-foot extension system. Combining a two-foot fixed extension system with the four- and six-foot adjustable extension system of the first embodiment permits, for example, an 18-foot vehicle to be used for 12-foot, 14-foot, and 16-foot roll-offs, in addition to the 18-foot roll-off it was originally designed for. These length numbers are just examples and not meant to limit the scope of the invention.

Limitations of a two-piece extendable bar . . . about twice its retracted length max, but practically, some overlap must be retained to preserve stiffness. Thus the choice of a 4 and 6 foot extension, a shorter bar is needed to get a two-foot extension. Unless one anticipates needing lengths between 2 and 4 feet, a two-foot extension need not be extendable to be useful, thus a second, fixed, shorter embodiment is a good complement to a longer, adjustable embodiment when certain predefined increments of length are needed.

The second embodiment, fixed extension-bar assembly 200 has a one-piece extension bar 202. Otherwise, fixed extension-bar assembly may have the same components as the adjustable extension-bar assembly 150 already described. Thus, assembly 200 may include latch assembly 154, latch-pin assembly 156, and support assembly 158 as described above. FIG. 16 indicates exemplary dimensions for extension bar 152 in its extended and retracted positions, respectively. The TABLE explains the meaning of the dimensions. The dimensions may be chosen according to the roll-off dimensions to be accommodated.

TABLE
Numbered parts in the drawings and specification.

| Numeral | Name | Also known as or options . . . |
|---|---|---|
| 100 | trailer | could be a truck |
| 102 | gooseneck | could be a bumper hitch |
| 104 | hitch or coupling | Fifth-wheel coupling |
| 106 | chassis | Trailer frame |
| 108 | axles | wheel options |
| 110 | lift frame | |
| 112 | lift pivot | |
| 114 | lift apparatus | hydraulic or electro- |
| | | mechanical |
| 115 | cable | tow cable |
| 116 | winch | ″ |
| 117 | hook | tow hook, with keeper |
| 118 | rail, angle iron | rail with embedded rollers |
| 120 | latch | |
| 121 | latch release pin | latch position lock pin |
| 122 | latch handle | |
| 123 | latch body | |
| 124 | latch pivot | |
| 125 | catch | or keeper or hook |
| 126 | transverse pivot rod | or tube |
| 127 | lever arm | |
| 128 | spring | or gravity |
| 130 | roll-off dumpster | flatbed, bin, container |
| 132 | front roller | rollers embedded in rail |
| 134 | rear roller | |
| 136 | latch bar | or latch pin or striker bar |
| 138 | towing eye | tow loop, ring, eye |
| 150 | Left Extension-bar | 1st embodiment, extendable, |
| | assembly | telescoping, left member |
| 150′ | right Extension-bar assembly | right member extension bar |
| 152 | telescoping extension bar | |
| 154 | latch assembly | Left latch assembly |
| 154′ | Latch assembly | right latch assembly |
| 156 | latch-pin assembly | left and right |
| | | latch-pin assembly |
| 158 | support assembly | |
| 160 | extension bar first part | Outer member or section |
| 162 | extension bar second part | Inner member or section |
| 164 | locking pin | |
| 165 | cotter pin | |
| 170 | first strike plate | latch body, fixed |
| | | latch portion |
| 170′ | second strike plate | latch body, fixed |
| | | latch portion |
| 170″ | latch body | |
| 172 | first latch hook | |
| 172′ | second latch hook | |
| 174 | latch handle | |
| 175 | latch handle lock pin | |
| 176 | latch pivot | |
| 177 | latch pivot extension plate | Attachment feature |
| 178 | first hole, latch | latch lock-pin hole, |
| | closed position | handle lock |
| 179 | second hole, latch | latch lock-pin hole |
| | open position | |
| 180 | latch pin or bar | strike bar or pin |
| 182 | first latch pin plate | |
| 184 | second latch pin plate | |
| 186 | eye for safety chain | |
| 188 | safety chain | |
| 190 | support pillar | vertical, column |
| 192 | support base | |
| 193 | support clamp plate | Attachment feature |
| 194 | support clamp bolt | clamp fastener |
| 195 | support brace bolt | brace fastener |
| 196 | support socket | |
| 197 | support brace | transverse brace |
| 197′ | latch-pivot rod assembly | Tube |
| 198 | brace rod or pivot rod | Tube |
| 199 | brace plate or pivot plate | Brace or pivot fastener |
| 200 | extension bar system | 2d embodiment, fixed length |
| 202 | extension bar | Non-extendable |
| A | overall length of ext. | Nominal length |
| | bar system 150 | |
| | in extended position | |
| B | working length, latch | |
| | to latch pin | |
| C | length of telescoped | Extension length |
| | section 162 | |
| D | overall length of extension | |
| | bar system 150 | |
| | in retracted position | |
| E | working length, latch | |
| | to latch pin | |
| F | length of retracted section 162 | |
| G | nominal length of fixed-length | |
| | extension bar system | |
| H | height of extension bar system | |

Although the present invention and its advantages have been described in detail, it should be understood that various changes, substitutions, and alterations can be made herein without departing from the scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps. The invention disclosed herein may suitably be practiced in the absence of any element that is not specifically disclosed herein.

What is claimed is:

1. A latch-extension system comprising an extension bar, a latch-pin assembly, a latch assembly, and a support assembly.

2. The latch-extension system of claim 1 wherein the latch-pin assembly is affixed to one end of the extension bar, the latch assembly is affixed to the other end of the extension bar, and the support assembly is affixed to the mid-section of the extension bar, but closer to the other end with the latch assembly.

3. The latch-extension system of claim 1 wherein the extension bar is telescoping.

4. The latch-extension system of claim 1 wherein the extension bar is of fixed length.

5. A latch-extension assembly comprising an extension bar, a latch-pin assembly, a latch assembly, and a support assembly.

6. A latch-extension system comprising a left form and a right form of the latch-extension assembly of claim 5.

7. The latch-extension system of claim 6 further comprising a bracing rod extending between and fastened to the respective support assemblies of the left form and the right form.

8. The latch-extension system of claim 6 further comprising a latch-pivot rod extending between and fastened to respective latch pivots of the latch assemblies.

9. A latch-extension system for a roll-off dumpster comprising an extension bar, a latch-pin assembly, a latch assembly, and a support assembly.

10. The latch-extension system of claim 9 wherein the latch-pin assembly is affixed to one end of the extension bar, the latch assembly is affixed to the other end of the extension bar, and the support assembly is affixed to the mid-section of the extension bar, but closer to the other end with the latch assembly.

11. The latch-extension system of claim 10 wherein the extension bar is telescoping.

12. The latch-extension system of claim 10 wherein the extension bar is of fixed length.

13. The latch-extension system of claim 10 comprising a left form and a right form of the latch-extension assembly of claim 10.

14. The latch-extension system of claim 13 further comprising a bracing rod extending between and fastened to the respective support assemblies of the left form and the right form of the latch assemblies.

15. The latch-extension system of claim 13 further comprising a latch-pivot rod extending between and fastened to the respective latch pivots of the left form and the right form of the latch assemblies.

16. The latch-extension system of claim 13 wherein the left form and the right form are mirror images.
